(19) United States
(12) Patent Application Publication
(10) Pub. No.: US 2008/0229927 A1
(43) Pub. Date: Sep. 25, 2008

(54) Filter cleaning control system and method

(75) Inventors: Avnit Singh, Overland Park, KS (US); Gregg John Zoltek, Lee's Summit, MO (US); Boris Bajic, Kansas City, MO (US); Thomas Rowland, Grandview, MN (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: BHA Group, Inc.

(21) Appl. No.: 11/728,233

(22) Filed: Mar. 23, 2007

(51) Int. Cl. B01D 46/04

(52) U.S. Cl. 95/281; 96/233

(57) ABSTRACT

A control system for use with a filter cleaning apparatus. The filter is supported in a housing and has a surface at which particulates are separated from a fluid stream passing through the filter and collected. The control system comprises a header for supplying pressurized fluid to at least one blowpipe to direct a stream of cleaning fluid into the filter to dislodge particulates from the surface of the filter. An actuatable valve is fluidly connected with the header and the blowpipe. Upon actuation, the valve permits pressurized fluid to flow from the header to the blowpipe. A wireless receiver is associated with the valve to actuate the valve upon receiving an actuation signal.

### BACKGROUND OF THE INVENTION

The invention relates generally to a system and method for cleaning fabric filter elements. In particular, the invention relates to a wireless system and method for controlling the cleaning of fabric filters.

It is known that fabric filters are used to separate particulates from the air flowing into a gas stream, such as inlet air for a gas turbine. The particulates tend to accumulate on and in the media of the fabric filter over time. This particulate accumulation increases resistance to flow through the fabric filters. Increased resistance to flow is undesirable because it inhibits fluid flow through the fabric filters and/or requires more power to effect flow through the fabric filters.

In some known systems, reverse pulse-jet cleaning is used to periodically remove accumulated particulates from the media of the fabric filters. Using reverse pulse-jet cleaning increases the service life of the fabric filters by removing accumulated particulates to decrease the resistance to fluid flow and allowing increased fluid flow through the fabric filters.

Reverse pulse-jet cleaning typically requires several headers. The headers supply pressurized fluid to blowpipes for directing a stream of cleaning fluid into the filter to dislodge particulates from the media of the fabric filters. An actuatable valve is fluidly connected with a given header and each blowpipe. A controller is hard-wired to each valve. The controller generates an actuation signal for a particular valve that is communicated over a dedicated wire to that particular valve.

Upon actuation the valve permits pressurized fluid to flow from the header to the blowpipe. The valve is actuated upon receiving an actuation signal over the wire from the controller in practice a plurality of actuatable valves are each fluidly connected with a respective header and a respective blowpipe. Upon actuation of each valve, pressurized fluid flows from the header to the respective blowpipe. A stream of cleaning fluid is directed into at least one filter to dislodge particulates from the surface of other filter.

Disadvantages with such a known system is the time required to hard wire each valve to the controller. Such wiring generally must be done on location and by hand by skilled labor. This is a costly operation. There is also a cost associated with the wire. Such wiring must be done while the filter system is offline. Such wiring can also be prone to errors and not detected until the system is online.

### BRIEF DESCRIPTION OF THE INVENTION

The invention overcomes the disadvantages of known filter cleaning control systems by eliminating much of the hardwiring. One aspect of the invention is a control system for use with a filter cleaning apparatus. The filter is supported in a housing and has a surface at which particulates are separated from a fluid stream passing through the filter and collected. The control system comprises a header for supplying pressurized fluid to at least one blowpipe to direct a stream of cleaning fluid into the filter to dislodge particulates from the surface of the filter. An actuatable valve is fluidly connected with the header and the blowpipe. Upon actuation, the valve permits pressurized fluid to flow from the header to the blowpipe. A wireless receiver is associated with the valve to actuate the valve upon receiving an actuation signal.

Another aspect of the invention is a cleaning control system for use with a gas turbine having a filter supported in a housing. The filter has a surface at which particulates are separated from a fluid stream passing through the filter and collected. The cleaning control system comprises a header for supplying pressurized fluid to at least one blowpipe to direct a stream of cleaning fluid into the filter to dislodge particulates from the surface of the filter. An actuatable valve is fluidly connected with the header and the blowpipe. Upon actuation, the valve permits pressurized fluid to flow from the header to the blowpipe. A wireless receiver is associated with the valve to actuate the valve upon receiving an actuation signal. A wireless transmitter generates and wirelessly communicates the actuation signal to the receiver.

Another aspect of the invention is a method of cleaning a filter supported in a housing. The filter has a surface at which particulates are separated from a fluid stream passing through the filter and collected. The cleaning method comprises the steps of supplying pressurized fluid to a header and to least one blowpipe for directing a stream of cleaning fluid into the filter to dislodge particulates from the surface of the filter. Providing an actuatable valve fluidly connected with the header and the blowpipe. Upon actuation the valve permitting pressurized fluid to flow from the header to the blowpipe. Receiving a signal to actuate the valve. Generating and wirelessly communicating the actuation signal to the receiver.

### BRIEF DESCRIPTION OF THE DRAWINGS

Further features of the invention will become apparent to those skilled in the art to which the invention relates from reading the following description with reference to the accompanying drawings, in which:

FIG. 1 is a schematic cross-sectional view of a filter apparatus having a filter cleaning control system according to one aspect of the invention;

FIG. 2 is a perspective view, taken from the inlet or upstream side of a portion of the filter cleaning control system illustrated in FIG. 1; and

FIG. 3 is a enlarged schematic view of a portion of the filter cleaning control system illustrated in FIG. 1

### DETAILED DESCRIPTION OF THE INVENTION

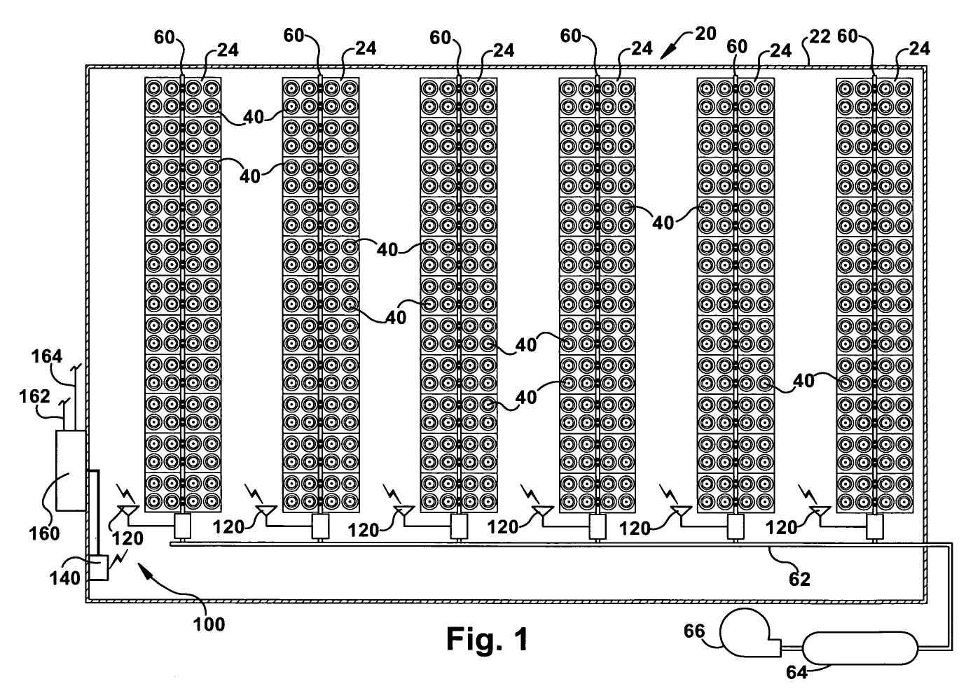

The control system and method of cleaning a fabric filter are disclosed below by way of example and not limitation. The control system and method may be used in a variety of fabric filter arrangements. FIGS. 1 through 3 depict one such fabric filter arrangement. The illustrated fabric filter arrangement is particularly suitable for a gas turbine intake filter apparatus 20 (FIG. 1).

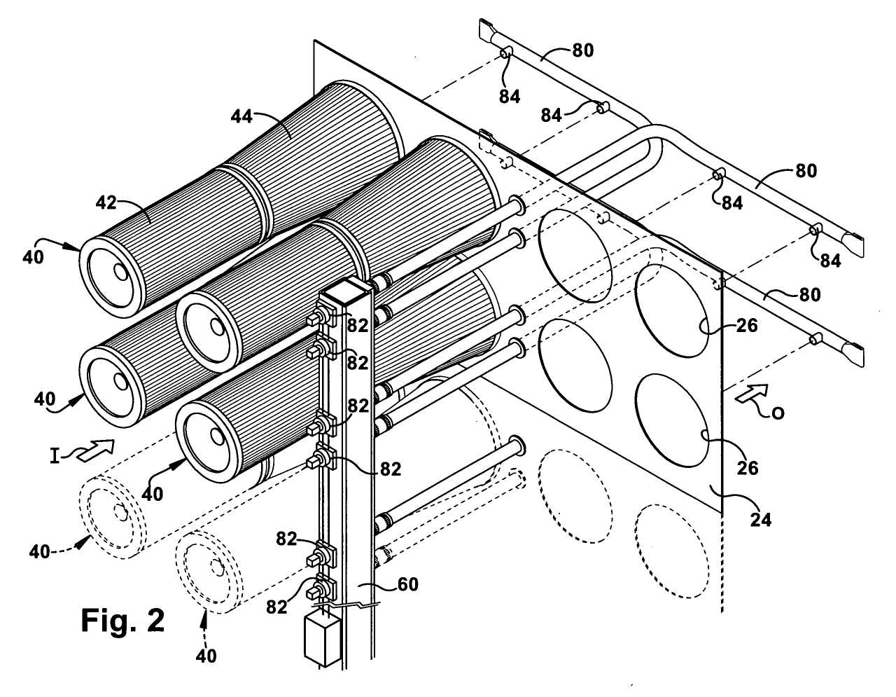

The gas turbine intake filter apparatus 20 includes a housing 22 and a frame (not shown) that is used to support a tube sheet 24 in the housing. The tube sheet 24 includes a plurality of openings 26 (FIG. 2). The gas turbine intake filter apparatus 20 includes a plurality of fabric filter assemblies 40 supported by the tube sheet 24 in a known manner. In the illustrated embodiment, six arrays of filter assemblies 40 are shown in the housing 22.

In FIG. 2, particulate-laden fluid, such as air, is drawn into the gas turbine intake filter apparatus 20 in the direction indicated by the arrow I. The fabric filter assemblies 40 are mounted adjacent to the openings 26 at an upstream side of the tube sheet 24.

Gas, such as inlet air for the gas turbine is cleaned by the media used to make the fabric filter assemblies 40. The cleaned air flows downstream from the openings 26 in the tube sheet 24 as indicted by arrows O into a downstream use component, such as, a gas turbine for power generation. Each of the illustrated fabric filter assemblies 40 includes at least one filter element 42, 44 positioned to clean the air before it is used by components located downstream of the filter assemblies. Air to be cleaned through the filter elements 42, 44. The filter elements 42, 44 are positioned in air flow communication with an opening 26 in the tube sheet 24. The cleaned air will flow through the opening 26 and then to downstream components.

Each filter assembly 40 includes a first filter element 42 and a second element 44 made from flexible, permeable fabric filter media material. Each of the first and second filter elements 42, 44 has an outer or upstream surface and an inner or downstream surface. The first filter element 42 is tubular and has a cylindrical shape. The second filter element 44 is tubular and has a frusto-conical shape. The pair of filter elements 42, 44 are arranged in axial engagement. It will be apparent that any type of filter element 42, 44 design may be used in the filter apparatus 20. One end of the first filter element 42 is closed by a removable end cap. The filter elements 42, 44 are held in place by mounting structure (not shown) attached to the tube sheet 24 and end cap. Each of the filter assemblies 40 defines a clean air plenum by its downstream or inner surface.

Each array of filter assemblies 40 includes a header 60. The header 60 is supported by the frame to extend in a substantially vertical orientation.

Each header 60 is connected to a common air supply line 62. The supply line 62 is connected a reservoir tank 64. The tank 64 is connected to a compressor 66.

The header 60 supplies pressurized fluid to at least one blowpipe 80 for directing a stream of cleaning fluid into the filter assemblies 40 to dislodge particulates from the media of the filter assemblies. The blowpipe 80 is constructed to direct a cleaning stream of fluid from nozzles 84 into at least a pair of filter assemblies 40 to dislodge particulates from the surface of the filter assemblies.

A plurality of actuatable valves 82 are aligned in a substantially vertical array along the header 60. Each valve 82 is fluidly connected with the header 60 and a respective blowpipe 80. Each valve 82 is normally closed and opens to permit flow upon actuation. Upon actuation each valve 82 permits pressurized fluid to flow from the header 60 to the associated blowpipe 80.

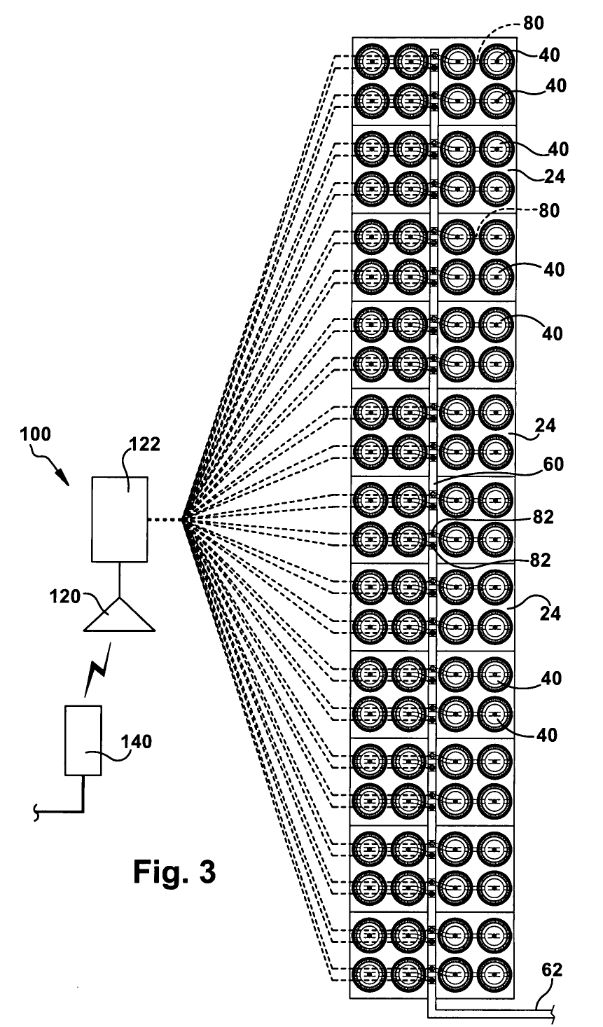

The control system 100 (FIGS. 1 and 3) includes a wireless receiver 120 associated with a respective header 60. The wireless receivers are also associated with each valve 82 to actuate the valve upon receiving an actuation signal. Each wireless receiver 120 is hardwired to respective valves 84 on the same header 60 that the wireless receiver is associated with. This can be done through a pre-assembled wiring assembly or harness 122. The wireless receiver 120 communication standard is selected from any suitable wireless radio frequency communication standard. Thus, the wireless receiver 120 eliminates the need for hardwiring each valve 82 with a controller enabling modular assembly off-site and cost savings with less chance of a wiring error. If such wiring error should occur it can be detected off-site and off-line.

The control system 100 further includes a wireless transmitter 140 to generate and wirelessly communicate the actuation signal to the receiver 120. The transmitter 140 is selected to match the communication standard of the receiver 120. The transmitter 140 communicates an actuation signal for each valve 82.

The control system 100 further includes a controller 160 (FIG. 1) in electrical communication with the transmitter 140 to determine when to generate the actuation signal in response to predetermined parameters communicated to the controller. The controller 160 may be in communication with downstream pressure drop sensors (not shown) over wires 162, 164 to function in response to a predetermined pressure drop. The controller 160 may be programmed to have the transmitter 140 generate an actuation signal when the pressure drop across the filter assemblies 40 reaches a predetermined value.

Actuation of the plurality of valves 82 occurs sequentially from the top of the array in a downward direction. This assures that dislodged particles from one filter assembly 40 does not fall onto a filter assembly 40 that has just been cleaned.

After a period of use, a pressure drop across each of the filter assemblies 40 will increase due to the accumulation of particulates separated from the air stream and accumulated on the filter assemblies. These particulates can be harmful to downstream components, such as a gas turbine, if not removed from the air stream. The filter assemblies 40 are periodically cleaned by directing a flow of relatively higher pressure fluid. The reverse pulse is directed into each filter assembly 40, essentially in a diverging direction along a longitudinal central axis of the filter assembly. The reverse cleaning pulse flows in a reverse direction of normal air flow through the filter assembly 40. This will remove at least some, and preferably a significant amount, of the particulates from the filter assembly 40 and reduce the restriction across the filter assembly 40 caused by particulates separated from the air stream accumulating on or in the fabric filter media.

The reverse cleaning pulse is provided by the cleaning control system 100 according to one aspect of the invention. Directing a pulse of compressed gas is done periodically into each filter assembly 40. By “periodic”, it is meant that the reverse pulse-jet control system 100 can be programmed or can be manually operated such that in desired periods, after a certain length of time or after a certain amount of restriction is detected in a known manner such as by sensing pressure drop, there will be a pulse of compressed gas directed through the filter assembly 40.

In general, the reverse pulse-jet cleaning control system 100 uses a flow of higher pressure fluid, such as pulses of compressed gas, such as air, to clean the filter assemblies 40. By “pulse”, it is meant a flow of fluid at a pressure at least 25%, and preferably at least 50%, higher than the pressure of the outlet flow O through filter assembly 40 for a limited time duration. The time duration is generally under 0.5 second, preferably under 0.3 second, and in some cases less than 0.05 second. It has been found that for certain applications, it is beneficial to direct the pulse P of compressed gas at a force of between 5-55 inches of water and flow at a rate in the range of 200 to 3000 CFM net flow, with developed “reverse”, or net reverse flushing flow of 25% to 100% of outlet flow O from the filter assembly 40. Preferably, the “net” reverse-air is at least 25 to 50% more than the normal outlet flow O of the filter assemblies 40 being cleaned.

Each of the valves 82 is arranged to direct the compressed fluid through a respective blowpipe 80 and to a pair of nozzles 84. Periodically, the valves 82 are operated to allow a pulse of compressed air to pass through the nozzles 84, through the openings 26 in the tube sheet 24, and into the filter assemblies 40. The nozzles 84 are positioned a predetermined distance from the tube sheet 24 and located along the axis of a respective filter assembly 40. The predetermined distance is the range of 8 inches to 36 inches, and preferably 20-31 inches when the diameter of the opening 26 in the tube sheet 24 is approximately 15 inches.

The blowpipe 80 is permanently secured to the tube sheet 24 or frame by a clamp or bracket. The nozzle 84 of the reverse pulse-jet cleaning control system 100 is permanently attached to the blowpipe 80, such as by welding. In the illustrated embodiment, the nozzle 84 is a fabricated from a metal tubular member and has a substantially constant circular cross-section extending along its length in a direction parallel to the longitudinal central axis.

In particular, the controller 160 of the reverse pulse-jet cleaning control system 100 will provide a signal to open the valve 82. When the valve 82 opens, a jet of compressed fluid flows from the header 60 through the valve and to the blowpipe 80. The jet enters the nozzles 84 as a primary fluid cleaning pulse. The cleaning pulse is directed into the associated filter assemblies 40.

Another aspect of the invention is a method of cleaning a filter assembly 40 mounted in a housing 22 at which particulates are separated from a fluid stream passing through filter media. The method of cleaning a filter supported in the housing comprises the steps of supplying pressurized fluid to a header 60 and to least one blowpipe 80 for directing a stream of cleaning fluid into the filter to dislodge particulates from the surface of the filter assembly 40. An actuatable valve 82 is fluidly connected with the header 60 and the blowpipe 80. Upon actuation, the valve 82 permits pressurized fluid to flow from the header 60 to the blowpipe 80. A receiver 120 receives a wireless signal to actuate the valve 82. A transmitter 140 generates and wirelessly communicates the actuation signal to the receiver 120.

From the above description of at least one aspect of the invention, those skilled in the art will perceive improvements, changes and modifications. Such improvements, changes and modifications within the skill of the art are intended to be covered by the appended claims.

Having described at least one aspect of the invention, what is claimed is:

1. A control system for use with a filter cleaning apparatus, the filter supported in a housing and having a surface at which particulates are separated from a fluid stream passing through the filter and collected, the control system comprising:
a header for supplying pressurized fluid to at least one blowpipe for directing a stream of cleaning fluid into the filter to dislodge particulates from the surface of the filter;
an actuatable valve fluidly connected with the header and the blowpipe, upon actuation the valve permitting pressurized fluid to flow from the header to the blowpipe; and
a wireless receiver associated with the valve to actuate the valve upon receiving an actuation signal.

2. The control system of claim 1 further including a wireless transmitter to generate and wirelessly communicate the actuation signal to the receiver.

3. The control system of claim 2 further including a controller in communication with the transmitter to determine when to generate the actuation signal in response to predetermined parameters communicated to the controller.

4. The control system of claim 1 further including a second actuatable valve fluidly connected with the header and another blowpipe, upon actuation the second valve permitting pressurized fluid to flow from the header to other blowpipe to direct a stream of cleaning fluid into another filter to dislodge particulates from the surface of other filter, and the wireless receiver associated with the second valve to actuate the second valve upon receiving a second actuation signal.

5. The control system of claim 1 wherein the blowpipe is constructed to direct a cleaning stream of fluid into at least a pair of filters to dislodge particulates from the surface of the filters.

6. The control system of claim 1 further including a plurality of actuatable valves each fluidly connected with the header and a respective blowpipe, upon actuation of each of the plurality of valves pressurized fluid flows from the header to the respective blowpipe to direct a stream of cleaning fluid into another filter to dislodge particulates from the surface of other filter, and the wireless receiver associated with the plurality of valves actuates only one of the plurality of valves upon receiving an actuation signal.

7. The control system of claim 6 wherein the header is disposed in a substantially vertical orientation and the plurality of valves being aligned in a substantially vertical array, and wherein actuation of the plurality of valves occurs sequentially from the top of the array in a downward direction.

8. A cleaning control system for use with a gas turbine having a filter supported in a housing and having a surface at which particulates are separated from a fluid stream passing through the filter and collected, the cleaning control system comprising:
a header for supplying pressurized fluid to at least one blowpipe for directing a stream of cleaning fluid into the filter to dislodge particulates from the surface of the filter;
an actuatable valve fluidly connected with the header and the blowpipe, upon actuation the valve permitting pressurized fluid to flow from the header to the blowpipe;
a wireless receiver associated with the valve to actuate the valve upon receiving an actuation signal; and
a wireless transmitter to generate and wirelessly communicate the actuation signal to the receiver.

9. The cleaning control system of claim 8 further including a second actuatable valve fluidly connected with the header and another blowpipe, upon actuation the second valve permitting pressurized fluid to flow from the header to other blowpipe to direct a stream of cleaning fluid into another filter to dislodge particulates from the surface of other filter, and the wireless receiver associated with the second valve to actuate the second valve upon receiving a second actuation signal.

10. The cleaning control system of claim 8 wherein the blowpipe is constructed to direct a cleaning stream of fluid into at least a pair of filters to dislodge particulates from the surface of the filters.

11. The cleaning control system of claim 8 further including a controller in communication with the transmitter to determine when to generate the actuation signal in response to predetermined parameters communicated to the controller.

12. The cleaning control system of claim 8 further including a plurality of actuatable valves each fluidly connected with the header and a respective blowpipe, upon actuation of each of the plurality of valves pressurized fluid flows from the header to the respective blowpipe to direct a stream of cleaning fluid into another filter to dislodge particulates from the surface of other filter, and the wireless receiver associated with the plurality of valves actuates only one of the plurality of valves upon receiving an actuation signal.

13. The cleaning control system of claim 8 wherein the header is disposed in a substantially vertical orientation and the plurality of valves being aligned in a substantially vertical array, and wherein actuation of the plurality of valves occurs sequentially from the top of the array in a downward direction.

14. A method of cleaning a filter supported in a housing and having a surface at which particulates are separated from a fluid stream passing through the filter and collected, the cleaning method comprising the steps of:
supplying pressurized fluid to a header and to least one blowpipe for directing a stream of cleaning fluid into the filter to dislodge particulates from the surface of the filter;
providing an actuatable valve fluidly connected with the header and the blowpipe, upon actuation the valve permitting pressurized fluid to flow from the header to the blowpipe;
receiving a wireless signal to actuate the valve; and
generating and wirelessly communicating the actuation signal to the receiver.

15. The cleaning method of claim 14 wherein the providing step further includes providing a second actuatable valve fluidly connected with the header and another blowpipe, upon actuation the second valve permitting pressurized fluid to flow from the header to other blowpipe to direct a stream of cleaning fluid into another filter to dislodge particulates from the surface of other filter, and the wireless receiver associated with the second valve to actuate the second valve upon receiving a second actuation signal.

16. The cleaning method of claim 14 wherein the supplying step includes the blowpipe constructed to direct a cleaning stream of fluid into at least a pair of filters to dislodge particulates from the surface of the filters.

17. The cleaning method of claim 14 further including the step of providing a controller in communication with the transmitter to determine when to generate the actuation signal in response to predetermined parameters communicated to the controller.

18. The cleaning method of claim 14 further including the step of providing a plurality of actuatable valves each fluidly connected with the header and a respective blowpipe, upon actuation of each of the plurality of valves pressurized fluid flows from the header to the respective blowpipe to direct a stream of cleaning fluid into another filter to dislodge particulates from the surface of other filter, and the wireless receiver associated with the plurality of valves actuates only one of the plurality of valves upon receiving an actuation signal.

19. The cleaning method of claim 14 wherein the supplying step includes the header disposed in a substantially vertical orientation and the plurality of valves being aligned in a substantially vertical array, and wherein actuation of the plurality of valves occurs sequentially from the top of the array in a downward direction.
